(19) United States
(12) Patent Application Publication
(10) Pub. No.: US 2024/0248214 A1
(43) Pub. Date: Jul. 25, 2024

(54) GNSS RECEIVER INITIALIZATION USING SECURE WIRELESS DATA TRANSFER

(71) Applicant: BAE Systems Information and Electronic Systems Integration Inc., Nashua, NH (US)

(72) Inventors: Michael G. Farley, Coggon, IA (US); Barry S. Lovseth, Marion, IA (US); Benjamin M. Graubard, Alburnett, IA (US); James K. Weighton, Central City, IA (US); Sean L. Heitz, Blue Grass, IA (US); Paul E. Jackson, Huntsville, AL (US)

(73) Assignee: BAE Systems Information and Electronic Systems Integration Inc., Nashua, NH (US)

(21) Appl. No.: 18/158,847

(22) Filed: Jan. 24, 2023

(51) Int. Cl. G01S 19/25; H04W 12/037

(52) U.S. Cl. CPC G01S 19/258; G01S 19/256; H04W 12/037

(57) ABSTRACT

Techniques for wireless initialization of GNSS receivers. An example system includes a source node and at least one GNSS receiver configured to track GNSS satellites and to provide navigation outputs, the GNSS receiver including a first wireless interface configured to implement a secure wireless communications protocol. The source node may include a second wireless interface configured for communications according to the secure wireless communications protocol, a data storage device storing GNSS configuration data that includes information for initializing the GNSS receiver, and at least one processor coupled to the first wireless interface and to the data storage device, and configured to execute instructions that control the source node to establish, via the second wireless interface, a secure wireless link with the at least one GNSS receiver using the secure wireless communications protocol, and transfer the GNSS configuration data to the GNSS receiver over the secure wireless link.

### FIELD OF DISCLOSURE

The present disclosure relates to wireless communications, and more particularly, to techniques for initializing navigation devices using secure wireless data transfer.

### BACKGROUND

GNSS receivers process signals transmitted by satellites and serve as the user interface to any Global Navigation Satellite System (GNSS), including the Global Positioning System (GPS) and other satellite-based systems and applications. GNSS receivers use data obtained by tracking a series of satellites to provide position and timing information that can be used for navigation, for example. The satellites used by GNSS receivers are usually not stationary, but circle around the globe on orbital paths. As a result, the individual satellites that are in view of a GNSS receiver at any given location and/or time may vary. Satellite almanac data, which may be retrieved from the satellites by the GNSS receiver, includes a set of parameters for each GNSS satellite in the system. GNSS receivers can use these parameters to calculate the approximate location in orbit of each corresponding GNSS satellite. Thus, the satellite almanac data may allow the GNSS receiver to determine which satellites are expected to be above the horizon for a particular time and geographic position of the GNSS receiver, and therefore which satellites are expected to be available for tracking. In some instances, a GNSS receiver can store satellite almanac data, as well as the receiver's last known position, in its on-board memory. After power-up, the GNSS receiver may access this stored information to determine which satellites are expected to be in view and potentially available to be tracked. At times, some expected satellites may be blocked from the GNSS receiver's view by buildings or mountains, for example, or may be otherwise unavailable for tracking (e.g., in a maintenance mode). In some systems, a GNSS receiver may need to track at least four satellites in order to compute its own current geographic position. If the GNSS receiver is unable to locate and track a sufficient number of satellites after power-up based on the available satellite almanac data, the GNSS receiver may begin scanning for all known satellites in its system until it is able to locate and track a sufficient number of satellites to operate in its normal mode and output correct navigational information. This process can take a considerable amount of time.

In some instances, the GNSS receiver may not have access to any stored satellite almanac data. In such instances, as soon as one satellite can be located, data can be received from that satellite. However, this may also take some time. For example, in some commercial systems, satellite almanac data may only be broadcast every 12.5 minutes. Thus, it may take up to 12.5 minutes after power-up for the GNSS receiver to acquire even a first satellite. As discussed above, the GNSS receiver will need to track more than one satellite in order to calculate its position, and therefore even more time may be needed after power-up until the GNSS receiver is able to acquire the satellites needed for it to operate properly in its normal mode. Thus, there remain a number of non-trivial issues with GNSS systems.

### SUMMARY

Aspects and embodiments are directed to techniques for wirelessly transferring data to GNSS receivers to improve ease of data transfer and shorten the amount of time taken for the GNSS receiver to become fully operational after power up.

According to one embodiment, a system for wireless initialization of GNSS receivers comprises at least one GNSS receiver node configured to track one or more GNSS satellites and to provide a navigation output, the at least one GNSS receiver node including a first wireless interface configured for wireless communications according to a first wireless communications protocol, and a source node. The source node includes a second wireless interface configured for wireless communications according to the first wireless communications protocol, a data storage device configured to store GNSS configuration data, the GNSS configuration data including information to be used by the at least one GNSS receiver node to initialize the at least one GNSS receiver node for navigational operation, and at least one processor coupled to the first wireless interface and to the data storage device. The at least one processor is configured to execute instructions that control the source node to establish, via the second wireless interface, a first wireless link with the at least one GNSS receiver node using the first wireless communications protocol, and transfer the GNSS configuration data to the at least one GNSS receiver node over the first wireless link.

Various examples of the system may include any one or more of the following features.

In one example, the first wireless link is a secure wireless link and the first wireless communications protocol is a secure wireless communications protocol.

In one example, the source node is another GNSS receiver comprising a full duplex transceiver.

In another example, the at least one GNSS receiver node includes a plurality of GNSS receivers, and the source node is configured to establish the secure wireless link with each GNSS receiver of the plurality of GNSS receivers and to transfer the GNSS configuration data to the plurality of GNSS receivers simultaneously.

In another example, the secure wireless communications protocol is an intra-soldier wireless (ISW) protocol.

In one example, the secure wireless link is an ultra-wideband radio frequency link.

In another example, the secure wireless link is a short-range communication link having a maximum communication range of 200 meters.

In another example, to establish the secure wireless link with the at least one GNSS receiver node, the source node is configured to pair with the at least one GNSS receiver node.

In one example, the GNSS configuration data includes satellite almanac data corresponding to a geographic location of the source node and the at least one GNSS receiver node.

In one example, for transfer over the secure wireless link, the GNSS configuration data is encrypted using AES-256 bit encryption.

In another example, the at least one GNSS receiver node comprises an additional wireless interface configured to receive satellite signals from the one or more GNSS satellites.

Another embodiment includes an apparatus for wireless initialization of GNSS receivers, the apparatus comprising a wireless interface configured for wireless communications according to a secure wireless communications protocol having a maximum range of 200 meters, a data storage device configured to store GNSS configuration data, the GNSS configuration data including information to be used by at least one GNSS receiver to initialize the at least one GNSS receiver for navigational operation, and at least one processor coupled to the wireless interface and to the data storage device. The at least one processor is configured to execute instructions to establish, via the wireless interface, a secure wireless link with the at least one GNSS receiver using the secure wireless communications protocol, and transfer the GNSS configuration data to the at least one GNSS receiver over the secure wireless link.

Various examples of the apparatus may include any one or more of the following features.

In one example, the secure wireless communications protocol has a maximum range of 10 meters. In one example, the secure wireless communications protocol is an intra-soldier wireless (ISW) protocol.

In one example, the at least one GNSS receiver includes a plurality of GNSS receivers, and the at least one processor is further configured to execute instructions to establish, via the wireless interface, secure wireless links with each of the plurality of GNSS receivers using the secure wireless communications protocol, and transfer the GNSS configuration data to the plurality of GNSS receivers simultaneously over the secure wireless links.

In one example, the GNSS configuration data includes satellite almanac data and timing information corresponding to a geographic location of the at least one GNSS receiver.

In another example, for transfer over the secure wireless link, the GNSS configuration data is encrypted using AES-256 bit encryption.

According to another embodiment, a GNSS receiver comprises a wireless communications interface configured for wireless communications according to an intra-soldier wireless (ISW) communications protocol, a user interface configured to display navigational output, at least one processor coupled to the wireless communications interface and to the user interface, and a data storage device storing instructions that when executed by the at least one processor configure the GNSS receiver to identify a source device within wireless communications range of the GNSS receiver, establish, via the wireless communications interface, a secure wireless communications link with the source device, the secure wireless communications link being configured according to the ISW communications protocol, receive, from the source device via the secure wireless communications link, GNSS configuration data, based on the GNSS configuration data, acquire a fix on at least one GNSS satellite, and based on signals received from the at least one GNSS satellite, produce the navigational output.

Various examples of the GNSS receiver may include any one or more of the following features.

In one example, to identify the source device, the at least one processor is configured to execute instructions that configure the GNSS receiver to identify a source device within 10 meters of the GNSS receiver.

In another example, the GNSS configuration data includes satellite almanac data and timing information corresponding to a geographic location of the GNSS receiver. In one example, the timing information includes at least one of Y-code data, M-code data, or C/A-code data.

In another example, the user interface includes a graphical user interface.

Still other aspects, embodiments, and advantages of these example aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

In the figures:

FIG. 1 is a block diagram of one example of a node-to-node wireless data transfer system for GNSS receivers according to aspects of the present disclosure;

FIG. 2 is a block diagram of another example of a node-to-node wireless data transfer system for GNSS receivers according to aspects of the present disclosure;

FIGS. 3A-C together are a sequence diagram illustrating an example of information flow between two GNSS receivers implementing a methodology for GNSS receiver initialization according to aspects of the present disclosure;

FIG. 4 is a block diagram of one example of a multicast wireless data transfer system for GNSS receivers according to aspects of the present disclosure; and

FIG. 5 is a block diagram of a processing platform configured to provide wireless data transfer for a GNSS receiver, in accordance with aspects of the present disclosure.

Although the following detailed description will proceed with reference being made to illustrative embodiments, many alternatives, modifications, and variations thereof will be apparent in light of this disclosure.

### DETAILED DESCRIPTION

Techniques are disclosed for initialization of GNSS receivers using wireless techniques. The techniques may be implemented, for example, as a system that includes a source node providing the initialization data via the wireless techniques to at least one GNSS receiver (receiver node) that is configured to track GNSS satellites and to provide navigation outputs. In one such embodiment, the GNSS receiver includes a separate wireless capability including a first wireless interface configured to implement a wireless communications protocol with the source node for the GNSS initialization data. The source node includes a second wireless interface configured for the wireless communications with the first wireless interface. In one embodiment the wireless communications is a secure wireless communications protocol. Also, the source node may include a data storage device storing GNSS configuration data that includes information for initializing the GNSS receiver, and at least one processor. The processor can be coupled to both the first wireless interface and the data storage device, and may be configured to execute instructions that control the source node to establish, via the second wireless interface, a secure wireless link with the at least one GNSS receiver using the secure wireless communications protocol. In this manner, the processor can cause the transfer of GNSS configuration data to the GNSS receiver over the secure wireless link. The source node can communicate unilaterally such that the receiver node just receives data. In another example the receiver node has transmit/receive capability such that the source node can establish bi-directional communications with at least one receiver node. In a further example the source node is also a GNSS receiver. One further example is where at least one of the GNSS receiver systems include the wireless communications capability and can operate as a source node in a peer-to-peer mode with the other receiver nodes.

### General Overview

As discussed above, there remain a number of non-trivial issues with GNSS systems. For example, in some instances, the GNSS receiver can store satellite almanac data, as well as the receiver's last known position, in its on-board memory, and access that information upon power-up. However, in some instances this information is either not available (e.g., has not be stored) or is out of date or incorrect or otherwise stale. For example, in some applications, a GNSS receiver may be powered down in one location and then powered up in a location very distant (e.g., in another state or even another country) from its previous location. As such, stored almanac data from the previous location may not be useful in assisting the GNSS receiver to acquire satellites at its new location. A GNSS receiver may perform a “cold start” in instances where it does not have a priori knowledge of its time and/or location. In such cases, the GNSS receiver can begin scanning for any satellite in its system, and as soon as one satellite is acquired, satellite almanac and timing data can be retrieved from that satellite. Each satellite broadcasts a unique code, referred to as a C/A code for commercial satellites, which can be used by a GNSS receiver to determine its own time. Once time and almanac data are available to the GNSS receiver, it can acquire other satellites for tracking, as may be needed to produce accurate navigational information. However, as discussed above, this process can take a significant amount of time (e.g., satellite almanac data is broadcast approximately every 12.5 minutes). Thus, in some instances, it can take up to about 15 minutes for a GNSS receiver to become fully operational following a cold start. Such delay may be intolerable for some applications. For example, in some military applications, particularly in contested environments, having accurate navigational information may be critical to mission success. Thus, it may be of very high importance to have GNSS receivers become fully operational after power up as quickly as possible. Furthermore, in contested environments, the C/A codes broadcast by commercial satellites can be blocked (“jammed”), thus preventing a GNSS receiver from acquiring the timing information it needs, which can further delay, or even prevent, the GNSS receiver becoming fully operational.

Accordingly, techniques are described herein for initializing GNSS receivers. For example, in some applications, to avoid the problems and delay associated with a cold start, the GNSS receiver can be provided with timing and satellite almanac data for its current location upon power up. This data can be transferred to the GNSS receiver from another device referred to as a source node (e.g., another, already operating GNSS unit, or some other device having the information stored thereon). With the correct time and current satellite almanac data, the GNSS receiver can perform a “warm start,” which may allow the GNSS receiver to become fully operational far more quickly than after a cold start. In a warm start mode, the GNSS receiver may know where to look to acquire satellites for tracking (based on the current almanac data), and therefore may not need to scan a large area to find the first satellite, and also need not wait for the almanac data to be broadcast.

In some instances, configuration data (e.g., timing and almanac data) can be transferred to a GNSS receiver via a wired connection (cable) with another device. However, such a wired connection may not be appropriate for all applications. For example, it takes time to connect the GNSS receiver to the other device with the cable, and only one GNSS receiver can be connected to a given source device at a time. Therefore, if many GNSS receivers all require the same configuration data, it can take a significant amount of time to connect each GNSS receiver to the source device using the cable(s). In addition, the data transfer rate using the cable may be slow. Furthermore, the use of the cable requires manual work by a human user and is prone to error (e.g., not properly connecting the cable, losing the cable, etc.), which can all cause further delay. As discussed above, there are several applications in which it may be critically important that the GNSS receiver become fully operational as quickly as possible after power-up, and thus it may be highly desirable to minimize any delay associated with initializing the GNSS receivers.

Accordingly, techniques are described herein for wirelessly transferring configuration data to one or more GNSS receivers, thereby enabling a warm start for the GNSS receivers. The techniques may be used to significantly reduce the time taken for GNSS receivers to become fully operational in new locations (i.e., a location different from the last known location of the GNSS receiver). Further, according to certain aspects, data transfer can be achieved using a short-range, encrypted, secure wireless communications protocol, which may increase reliability, particularly in potentially contested environments. The short range can also lessen detection of the communications and mitigate efforts to jam or spoof the communication between the source node and the receiver node.

In accordance with one embodiment, a system is provided for wireless initialization of GNSS receivers. Examples of the system include a source node, and at least one receiver node that includes a GNSS receiver configured to track one or more GNSS satellites and to provide a navigation output. The at least one receiver node including a first wireless interface configured for wireless communications according to a secure wireless communications protocol. In some examples, the source node includes a second wireless interface configured for wireless communications according to the secure wireless communications protocol, a data storage device configured to store GNSS configuration data, the GNSS configuration data including information to be used by the at least one GNSS receiver to initialize the at least one GNSS receiver for navigational operation, and at least one processor coupled to the first wireless interface and to the data storage device. At least one processor can be configured to execute instructions that control the source node to establish, via the second wireless interface, a secure wireless link with the at least one receiver node using the secure wireless communications protocol, and transfer the GNSS configuration data to at least one receiver node over the secure wireless link. In this manner, a warm start for the GNSS receiver(s) is achieved.

### System Architecture

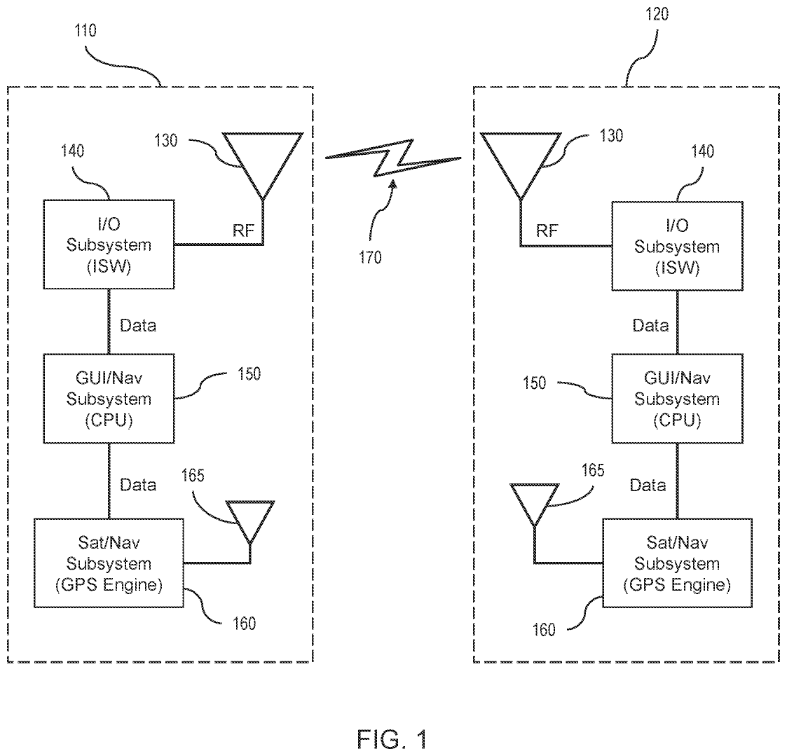

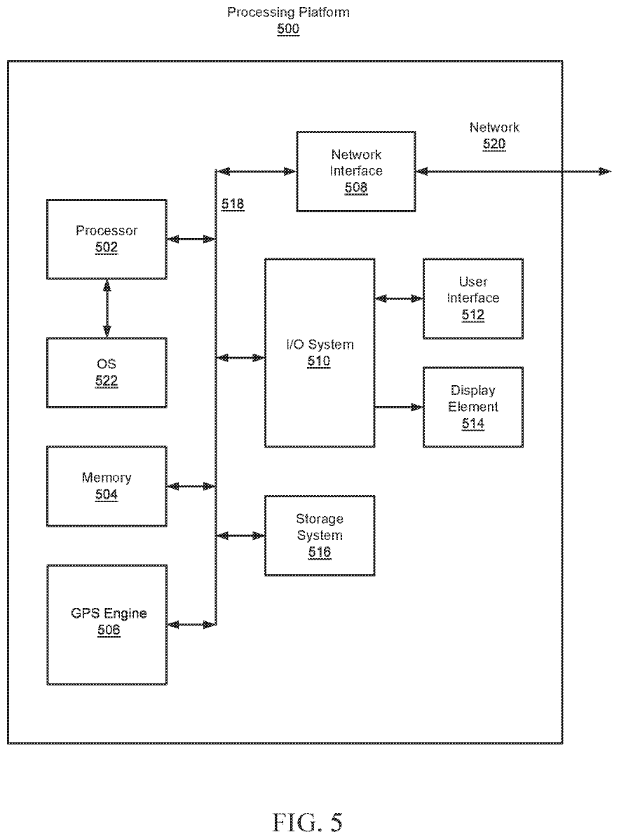

Referring to FIG. 1, there is illustrated one example of a node-to-node wireless data transfer system for GNSS receivers in accordance with aspects of the present disclosure. The system includes a source device (also referred to as a source node) 110 and a receiver device (also referred to as a receiver node) 120. The source node 110 has acquired current configuration data and can provide it to the receiver nodes. The source node 110 may have the configuration data stored in an on-board data storage device (such as data storage device 516 discussed below with reference to FIG. 5) or otherwise be able to acquire the configuration data. In this example the source node 110 includes a GNSS receiver having a GNSS antenna 165 and a GNSS engine 160.

The receiver node 120 in this example includes a radio frequency (RF) antenna 130, an input/output (I/O) subsystem 140, a user interface and navigation subsystem 150, a satellite navigation subsystem 160 and separate RF or satellite antenna 165. The satellite navigation subsystem 160 in one example is a GNSS engine of the GNSS receiver coupled to a GNSS antenna 165. In a further example, a single antenna or antenna array with wideband capability is used in place of two separate antenna elements.

The I/O subsystem 140 in one example is coupled to the antenna 130 and configured to implement the wireless communication protocols and processes needed to enable the source node 110 to wirelessly communicate with the receiver node 120 (and optionally other devices), as discussed herein. Accordingly, the I/O subsystem 140 may include a wireless RF interface including one or more RF radios (e.g., transmitters and/or receivers) coupled to the at least one antenna 130 and configured to implement wireless communications using one or more communication protocols. In some examples, the I/O subsystem 140 may be configured to provide a secure wireless interface for data transfer between the source node 110 and the receiver node 120, as discussed herein. In particular, the I/O subsystem 140 may include circuitry, such as amplifier(s), encoder(s)/decoder(s), mixer(s), and/or other circuitry associated with a full duplex wireless transceiver, to allow the receiver node 120 to transmit information to and receive information from the source node 110 using a secure wireless link and transmission protocol, as discussed further below. Thus, although certain devices (such as the receiver node 120) may be referred to herein as a GNSS receiver (with, in some instances, a primary function being to receive navigational information from one or more satellites and provide navigational output for a user), these GNSS receivers may have short-range transmission capability to allow exchange of information between source nodes 110 and receiver nodes 120 via the secure wireless interface provided by the I/O subsystem 140. Examples of the I/O subsystem 140 are discussed further below with reference to FIG. 5.

The user interface and navigation subsystem 150 may include one or more central processors that control operation of the receiver node 120. The user interface and navigation subsystem 150 may also provide a user interface to allow a user to interact with the GNSS receiver and to view navigation output provided by the GNSS receiver once operating in its normal mode. In some instances, the user interface may be or may include a graphical user interface (GUI). The user interface and navigation subsystem 150 is coupled to and exchanges data with the I/O subsystem 140 and the satellite navigation subsystem 160. In some examples, some functionality of the user interface portion of the user interface and navigation subsystem 150 may be implemented via the I/O subsystem 140. Examples of the processor(s) and user interface components are discussed in more detail below with reference to FIG. 5.

The receiver node 120 includes a GNSS receiver that has been powered up without current configuration data, and therefore may acquire the configuration data from the source node 110. The satellite navigation subsystem 160 or GNSS receiver includes a GNSS antenna 165 and a GNSS engine that performs processing on signals received via the GNSS antenna 165 to produce the navigational output for the GNSS receiver. In examples, unlike the I/O subsystem 140 and associated antenna 130 which have transmission capability, the satellite navigation subsystem 160 only receives GNSS signals from one or more satellites via the GNSS antenna 165, but does not transmit using the GNSS antenna 165. The satellite navigation subsystem 160 is coupled to the user interface and navigation subsystem 150 and exchanges data with the user interface and navigation subsystem 150. In some instances, some of the processing performed by the GNSS engine of the satellite navigation subsystem 160 may be implemented using one or more processors associated with the user interface and navigation subsystem 150, as discussed further below with reference to FIG. 5. Various aspects of the satellite navigation subsystem 160, the user interface and navigation subsystem 150, and/or the I/O subsystem 140 may be implemented in hardware, firmware, and/or software, or any suitable combination of hardware, firmware or software.

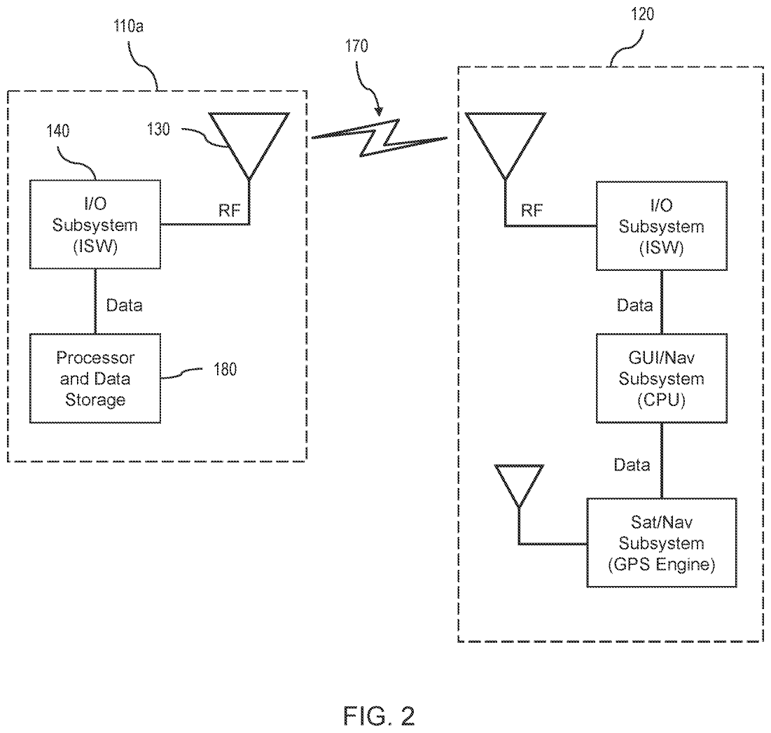

In the example illustrated in FIG. 1, the source node 110 is a GNSS receiver, equipped with the I/O subsystem 140 having a secure wireless interface with full duplex transmission/reception capabilities, as discussed above, and therefore may include the same components and circuitry as the receiver node 120. However, other examples, the source node 110 may be any type of device that can store the configuration data and wirelessly transmit the configuration to the receiver node 120 using an appropriate wireless communications protocol. Accordingly, referring to FIG. 2, in some examples, a source node 110a includes at least one RF antenna 130, the I/O subsystem 140 as discussed above, and circuitry 180 that may include at least one processor coupled to one or more data storage devices. Examples of the circuitry 180 are discussed further below with reference to FIG. 5.

Referring to FIGS. 1 and 2, the source node 110/110a and the receiver node 120 may communicate with one another via a wireless communications channel or link 170. In particular, the source node 110/110a may transfer the configuration data to the receiver node 120 via the wireless communications link 170. In some examples, the wireless communications link 170 is implemented using ultra-wideband (UWB) RF technology. UWB is a short-range wireless communications protocol that can use very low energy levels for high-bandwidth communications over a large portion of the radio spectrum. Thus, using UWB may allow the source node 110 to transfer the configuration data to the receiver node 120 at high data rates. In some examples, the data rate for the wireless transfer of the configuration data may be one or more orders of magnitude faster than the data rates that can be achieved using the cable transfer discussed above. In other examples, the wireless communications link 170 may be implemented using a short-range wireless technology other than UWB, such as Bluetooth® or a WiFi standard (e.g., using a 2.4, GHZ, 5 GHz, or 6 GHz WiFi band), for example.

As noted above, the wireless link 170 may be a short-range link. In some examples, when implemented using UWB, the range of the wireless link 170 may be up to about 200 meters, or up to about 50 meters, within reasonable tolerances, and depending on environmental conditions. When implemented using Bluetooth, the range of the wireless link 170 may be up to about 30 meters, up to about 20 meters, or up to about 10 meters, within reasonable tolerances and depending on environmental conditions. When implemented using WiFi, the range of the wireless link 170 may be up to about 90 meters, up to about 70 meters, or up to about 46 meters, within reasonable tolerances and depending on environmental conditions and the frequency band used. When implemented using Intra-Solider Wireless (ISW), the range of the wireless link 170 may be up to about 10 meters within reasonable tolerances and depending on environmental conditions. For example, because it uses narrower wavelengths, a 5 GHz Wi-Fi connection is generally more susceptible to obstructions than 2.4 GHz connections, and therefore may have a slightly shorter effective range, for example, 3-4.5 meters shorter. In contrast, the GNSS satellites tracked by the GNSS receiver orbit at many thousands of kilometers above the surface of the earth, for example, about 20,000 km for some systems. Accordingly, the signal link between the GNSS receiver and the satellites can be considered long-range.

In certain examples, communication between the source node 110 and the receiver node 120 over the wireless communications link 170 may be implemented using a secure, encrypted communications protocol, such as the intra-soldier wireless (ISW) protocol used by the US military. In such examples, the I/O subsystem 140 may be configured to provide a secure wireless interface configured to implement the ISW protocol. For example, the I/O subsystem 104 may include an ISW module, such as that available from Alereon, Inc. headquartered in Austin, Texas. The ISW module may be an NSA certified device that uses Type 1 encryption, and thus is approved for military applications. Type 1 encryption refers to NSA-endorsed encryption or cryptographic schemes suitable for encrypting and decrypting classified and sensitive national security information. In some applications, such as military applications in potentially contested environments, the use of ISW may have several advantages. For example, ISW is short range, having a maximum range of about 10 meters in some examples, which may help to provide low probability of detection (LPD) and/or low probability of intercept (LPI) of the data being transferred. In addition, ISW uses a secure modulation scheme and encryption, which may both further assist in reducing LPD and LPI.

In other examples, the wireless communications link 170 may be implemented using a secure communications protocol other than ISW. Accordingly, the I/O subsystem 140 may include a wireless interface that is configured to implement a communications protocol that uses a modulation scheme selected to reduce LPD and LPI, optionally in combination with encryption, in some examples. For example, the I/O subsystem 140 may be configured to use AES-256 bit encryption. AES encryption refers to the Advanced Encryption Standard (AES), which is a symmetric cryptographic algorithm that was established by the U.S. National Institute of Standards and Technology (NIST).

As discussed above, the source node 110 may transfer configuration data to the receiver node 120 to enable the receiver node to perform a warm start and become fully operational as GNSS receiver more quickly. Accordingly, the configuration data may include information needed by the receiver node 120 for initialization of the satellite navigation subsystem 160, for example. In particular, in some examples, the configuration data may include information that the satellite navigation subsystem 160 can use to reduce the time to acquire the first satellite (referred to as “Time To First Fix”). Accordingly, as discussed above, the configuration data may include satellite almanac data. The configuration data may also include the current time and position of the source node 110, and therefore of the receiver node 120 (since the wireless communications link 170 may be relatively short range) to within acceptable accuracy. The configuration data may include C/A code almanac data. In military applications, the configuration data may include Y-code and/or M-code almanac data. As discussed above, the C/A code data corresponds to unique satellite identification information broadcast by commercial satellites, which can be used by a GNSS receiver to determine its own time. Y-code and M-code data may include similar information in encrypted formats used by the US military. In some examples, the configuration data can also mission data, such as waypoints, routes, alerts, and/or maps.

### Methodology

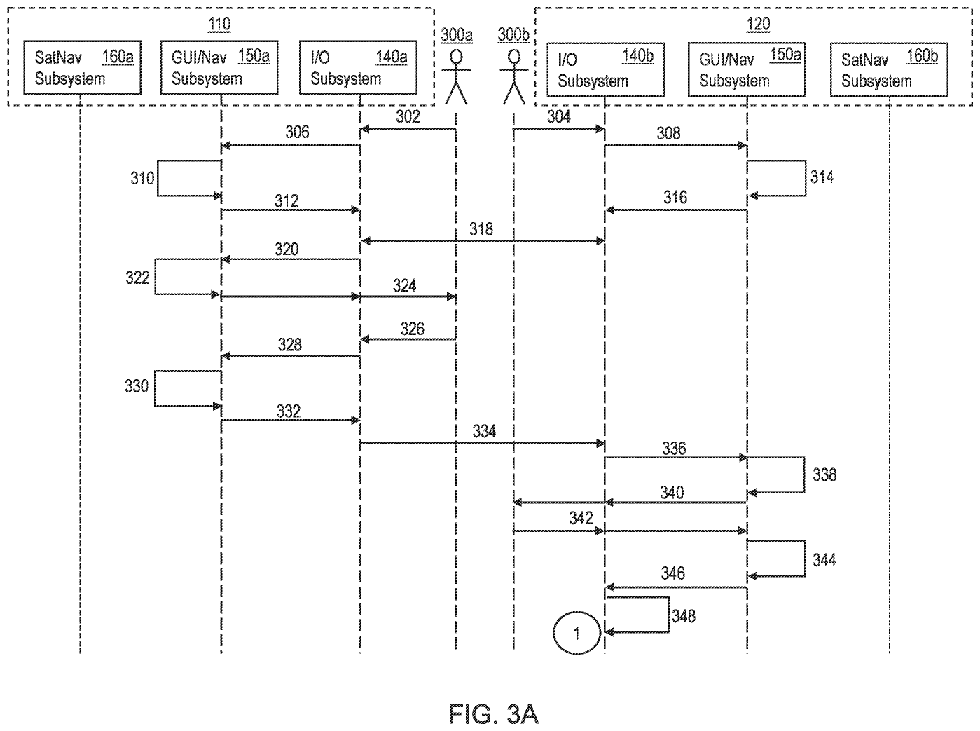

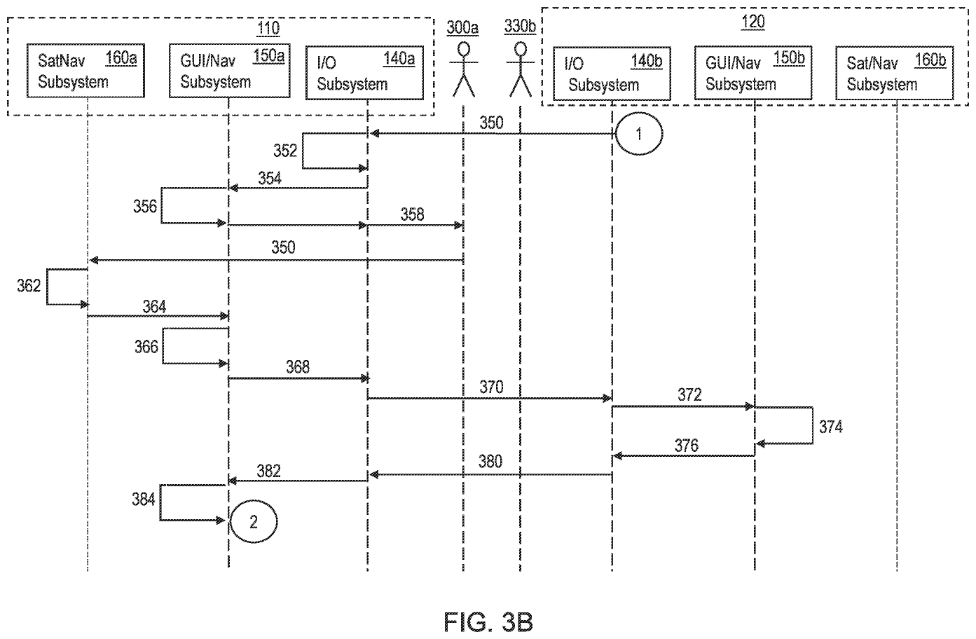

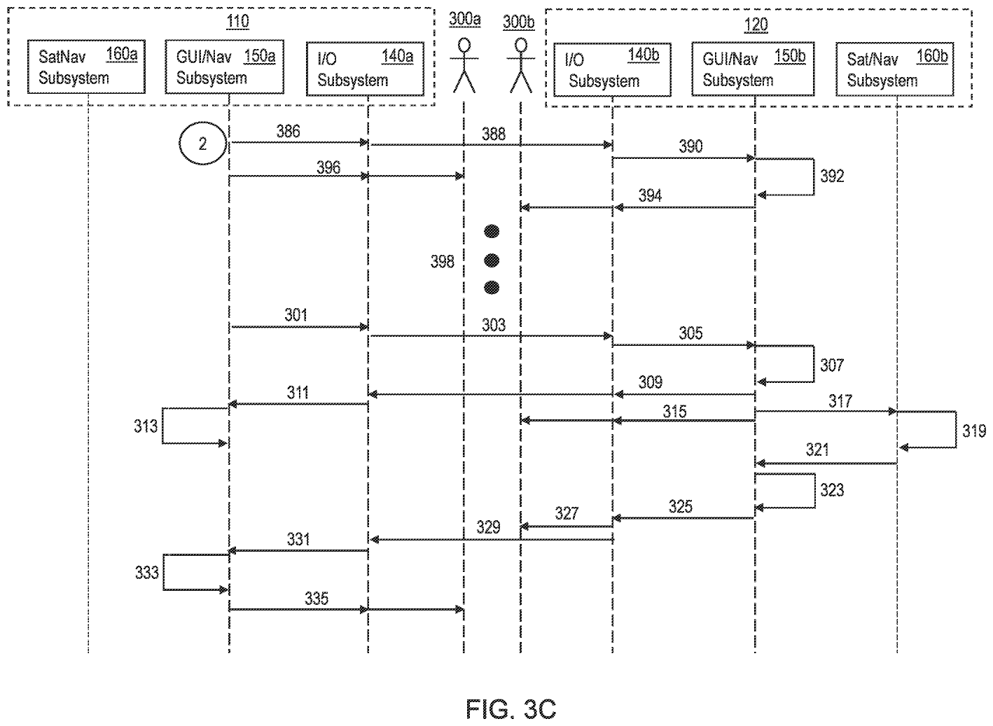

FIGS. 3A-C together illustrate a sequence diagram for one example of node-to-node wireless transfer of configuration data between two GNSS receivers, in accordance with aspects disclosed herein. In this example, the source node 110 and receiver node 120 are both GNSS receivers, as in the example shown in FIG. 1A. However, it will be appreciated that the information flow can be adapted to the situation in which the source node 110a is not necessarily a GNSS receiver (as in the example shown in FIG. 2). In the example shown in FIGS. 3A-C, the source node is associated with a first user 300a and the receiver node 120 is associated with a second user 300b. Examples of the sequence shown in FIGS. 3A-C may be performed when the GNSS receiver corresponding to the receiver node 120 is powered up.

Referring to FIG. 3A, at 302, the first user 300a of the source device 110 may select an appropriate wireless interface configuration for the I/O subsystem 104a of the source node 110 to enable the source node 110 to communicate with the receiver node 120 over the wireless link 170. As discussed above, in some instances, this may correspond to an ISW mode (i.e., I/O subsystem 140a is configured in accord with the ISW communications protocol); however, in other examples, a different protocol may be used. For clarity, the following discussion may refer to ISW mode and the use of the ISW protocol; however, it will be understood that in other examples, a different protocol may be used, as discussed above. At 304, the second user 300b associated with the receiver node 120 may similarly select the ISW mode to prepare the receiver node to communicate with the source node 110. As discussed above, communication between the I/O subsystem 140aof the source node 110 and the I/O subsystem 140b of the receiver node 120 occurs wirelessly over the wireless communications link 170.

In some examples, one or more parameters of the communications protocol (e.g., frequency band, modulation, channel width, etc.) used for data transfer over the wireless link 170 may be different from those used when the GNSS receiver is receiving, via the GNSS antenna 165, signals from satellites during normal operation. Accordingly, selecting the ISW mode at 302 may include reconfiguring all such a parameters as necessary. In some examples, the source node 110 may be configured to continue to track satellites in accord with normal operations while the data transfer of the configuration data to the receiver node 120 is occurring. In such examples, selecting the ISW mode may include activating a wireless interface coupled to one RF antenna 130 without disrupting operations of the satellite navigation subsystem 160 and the GNSS antenna 165 being used for satellite signal reception.

At 306, the I/O subsystem 140a of the source node 110 routes the first user input to the user interface and navigation subsystem 150a. Similarly, at 308, the I/O subsystem 140b of the receiver node 120 routes the second user input to the user interface and navigation subsystem 150b. At the source node 110, at 310, the user interface and navigation subsystem 150a processes the first user input and instructs the I/O subsystem 140a to enable ISW mode and start searching for the wireless link 170 (at 312). Similarly, at the receiver node, at 314, the user interface and navigation subsystem 150b processes the second user input and instructs the I/O subsystem 140b to enable ISW mode and start searching for the wireless link 170 (at 316). At 318, the devices search for and establish the wireless link 170.

At the source node, at 320, the I/O subsystem 140a notifies the source node 110 of the availability of the receiver node 120 to receive the configuration data. At 322, the user interface and navigation subsystem 150a processes the information and provides the first user 300a with a request for authorization (at 324) to communicate with the receiver node 120. At 326, the first user 300a authorizes pairing between the source node 110 and the receiver node 120. The authorization is transferred to the user interface and navigation subsystem 150a at 328. At 330, the user interface and navigation subsystem 150a processes the authorization confirmation and indicates, at 332, to the I/O subsystem 140a that pairing with the receiver node 120 is authorized. At 334, the source node 110 sends a pairing request to the receiver node 120.

The receiver node 120 receives (at 336) and processes (at 338) the pairing request, and at 340, requests pairing authorization from the second user 300b. At 342, the second user 300b authorizes the pairing, and the authorization is passed to the user interface and navigation subsystem 150b. At 344, the user interface and navigation subsystem 150b processes the pairing authorization, and at 346 instructs the I/O subsystem 140b that pairing with the source node 110 is authorized. At 348, the I/O subsystem 140b processes the pairing authorization.

Referring to FIG. 3B, at 350, the receiver node 120 sends an authorized pairing notice to the source node 110. At 352, the I/O subsystem 140a authenticates the authorized pairing notice. At 354, the I/O subsystem 140a passes the notice of authorized pairing to the user interface and navigation subsystem 150a. At 356, the user interface and navigation subsystem 150a processes the notice of authorized pairing, and at 358 informs the first user 300a that the receiver node 120 has been paired with the source node 110.

At 360, a request for a warm start data transfer is provided to the satellite and navigation subsystem 160a. At 352, the satellite and navigation subsystem 160a processes the request for configuration data transfer, and at 364, provides a configuration dataset to the user interface and navigation subsystem 150a. At 366, the user interface and navigation subsystem 150a processes the configuration data for transfer, and at 368 sends an instruction to the I/O subsystem 140a to initiate the configuration data transfer. At 370, the I/O subsystem 140a initiates transfer of the configuration data to the receiver node 120. At 372, the I/O subsystem 140b routes a data transfer request to the user interface and navigation subsystem 150b. The user interface and navigation subsystem 150b processes the data transfer request at 374, and at 376 sends confirmation to the I/O subsystem 140b. At 380, the receiver node 120 sends confirmation for data transfer to the source node 110. At 382, the I/O subsystem 140a routes the data transfer confirmation to the user interface and navigation subsystem 150a, which processes the confirmation at 384.

Referring to FIG. 3C, transfer of the configuration data from the source node 110 to the receiver node 120 now begins. At 386, a first packet of configuration data is routed from the user interface and navigation subsystem 150a to the I/O subsystem 140a, which transfers the first packet of configuration data to the I/O subsystem 140b (at 388). The first packet of configuration data is routed to the user interface and navigation subsystem 150b (at 390) where it is processed at 392. At 394, the user interface and navigation subsystem 150b reports the status of the data transfer to the second user 300b. At 396, the user interface and navigation subsystem 150a reports the status of the data transfer to the first user 300a. The process repeats for each packet of configuration data, as indicated at 398.

At 301, the last packet of configuration data is routed from the user interface and navigation subsystem 150a to the I/O subsystem 140a, which transfers the first packet of configuration data to the I/O subsystem 140b (at 303). The last packet of configuration data is routed to the user interface and navigation subsystem 150b (at 305) where it is processed at 307. At 309, a request for confirmation of completion of the data transfer is sent from the receiver node 120 to the source node 110. The confirmation request is routed to the user interface and navigation subsystem 150a at 311, where it is processed at 313. At 315, the user interface and navigation subsystem 150b reports the status of the data transfer to the second user 300b. At 396, the user interface and navigation subsystem 150a reports the status of the data transfer to the first user 300a. At 317, at the receiver node, the configuration data is routed to the satellite and navigation subsystem 160b, where it is processed at 319.

At 321, the satellite and navigation subsystem 160b provides a notice indicating either successful transfer of the configuration data or failure of the data transfer. At 323, the user interface and navigation subsystem 150b processes the notice. At 325, the user interface and navigation subsystem 150b reports success or failure of the data transfer. If the data transfer was successful, at 327, a display (e.g., the display element 514 discussed below with reference to FIG. 5) and/or other external interfaces are updated. At 329, confirmation of completion of failure of the configuration data transfer is sent from the receiver node to the source node. At 331, the confirmation notice is passed to the user interface and navigation subsystem 150a, where it is processed at 333. Confirmation of completion or failure of the configuration data transfer is reported to the first user 300a at 335.

Thus, node-to-node wireless transfer of configuration data from a source device to another GNSS receiver can be accomplished. As discussed above, the data transfer can be performed over a secure wireless link 170, making the process suitable for military application and/or other applications in which it may be preferable to protect the configuration data from interception by other entities. As also discussed above, the wireless link 170 may support high data rates, allowing the transfer of the configuration data to be performed quickly. In addition, unlike a physical, wired connection, which may support only a one-to-one connection, using a wireless interface allows the ability to use multicast to communicate with multiple receiving devices at the same time.

### Example Use Case

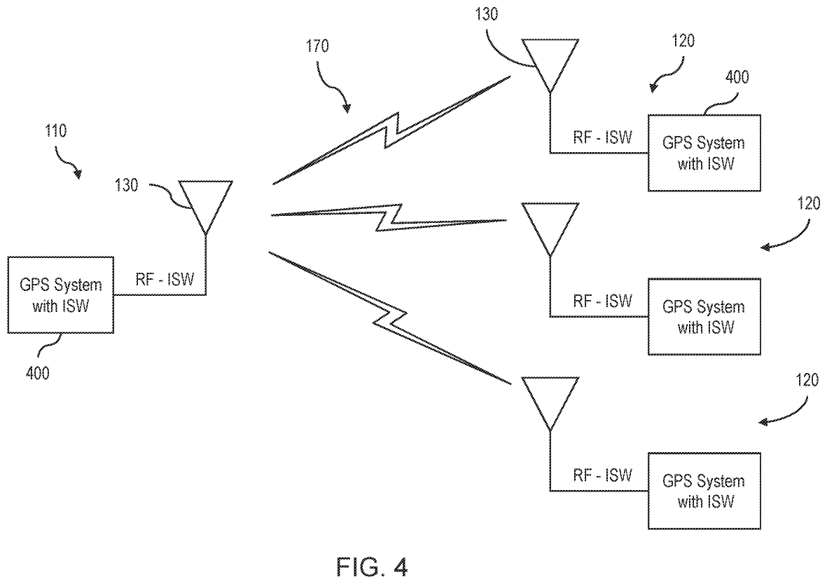

For example, referring to FIG. 4, there is illustrated an example in which a single source device 110 may wirelessly transfer the configuration data to multiple receiving devices 120 simultaneously over the wireless link 170. In the illustrated example, the source device 110 and the receiving devices 120 are all GNSS units; however, as discussed above, in other examples, the source device 110a need not be a GNSS receiver and can be any device capable of storing and wirelessly transferring the configuration data. In the example illustrated in FIG. 4, the source device 110 and each of the receiving devices 120 includes a GNSS system 400 having an appropriate secure wireless interface (e.g., the I/O subsystem 140 discussed above) coupled to at least one RF antenna 130. In some examples, the GNSS system 400 includes the input/output (I/O) subsystem 140, the user interface and navigation subsystem 150, and the satellite navigation subsystem 160 discussed above. In some examples, the GNSS system 400 may be implemented using a computing platform 500 as discussed below with reference to FIG. 5. In the example illustrated in FIG. 4, the GNSS system 400 includes an ISW interface configured to implement the ISW communications protocol for wireless data transfer via the antenna 130, as discussed above. However, as also discussed above, in other examples, the GNSS system 400 may be configured to implement one or more other wireless communications protocols and examples are not limited to the use of ISW.

The use of a secure wireless communications interface, such as the I/O subsystem 140 and associated antenna 130 discussed above, advantageously allows the source node 110 to wirelessly transmit the configuration data to the multiple receiving devices 120 simultaneously, which provides much faster data transfer than having to individually connect each receiving device 120 to the source node using a specialized cable. This allows the receiving devices 120 to become fully operational more quickly, which can be highly advantageous in many circumstances. In addition, providing full duplex transmission/reception capability, as discussed above, advantageously allows the source/receiving devices to exchange other information, such as position, navigation, and/or time information, for example, (not only configuration data) with each other and/or with other devices that are equipped with a compatible secure wireless interface. In certain examples, the source device 110 equipped with the I/O subsystem 140 may act as a “hub,” relaying information to other devices (not necessarily limited to GNSS receivers) that are equipped to communicate using compatible secure wireless protocols.

In one example, any of the GNSS Systems with ISW 400 can function as the peer in a peer-to-peer mode and become the source node 110 that has acquired the entire data set and becomes a seed that transmits the data to the other receiver nodes 130 or peers.

Thus, aspects and embodiments provide a secure wireless interface for transfer of configuration and/or other data between GNSS receivers, or from other source devices to GNSS receivers. Implementations of the systems and methodology disclosed herein may provide an accelerated path for initializing multiple GNSS receivers, optionally under adverse conditions (e.g., in contested environments and/or where other sources of configuration data may not be readily available), thereby enhancing the utility and performance of the GNSS receivers.

### Example Platform

FIG. 5 is a block diagram of a processing platform configured to provide RF wireless configuration data transfer in accordance with aspects of the present disclosure. The computing platform 500 may be part of a GNSS receiver, and may be used to implement various components of the source devices 110, 110a and/or receiving devices 120 discussed above. In some examples, the computing platform 500, or portions thereof, may be hosted on, or otherwise be incorporated into the electronic systems of an aircraft, a projectile, a space-based platform, a ground based platform, or a handheld platform in which GNSS signals are received and/or transmitted based on a given standard. Any combination of different devices may be used in certain embodiments.

In some embodiments, the computing platform 500 may comprise any combination of a processor 502, a memory 504, a GNSS engine 506, a network interface 508, an input/output (I/O) system 510, a user interface 512, a display element 514, and a storage system 516. As can be further seen, a bus and/or interconnect 518 is also provided to allow for communication between the various components listed above and/or other components not shown. The computing platform 500 can be coupled to a network 520 through the network interface 508 to allow for communications with other computing devices, platforms, devices to be controlled, or other resources. Other componentry and functionality not reflected in the block diagram of FIG. 5 will be apparent in light of this disclosure, and it will be appreciated that other embodiments are not limited to any particular hardware configuration.

The processor 502 can be any suitable processor, and may include one or more coprocessors or controllers, such as an audio processor, a graphics processing unit, or hardware accelerator, to assist in the execution of mission software and/or any control and processing operations associated with platform 500. In some embodiments, the processor 502 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array (FPGA) or other device configured to execute code. The processors may be multithreaded cores in that they may include more than one hardware thread context (or “logical processor”) per core. The processor 502 may be implemented as a complex instruction set computer (CISC) or a reduced instruction set computer (RISC) processor. In some embodiments, the processor 502 may be configured as an x86 instruction set compatible processor. The processor 502 can be configured to perform any of the various functions and processes described herein and with reference to FIGS. 2-4. In some examples, the processor 502 may include the processor(s) forming part of the user interface and navigation subsystem 15 discussed above. Similarly, in some examples, the processor 502 may include the processor(s) forming part of the circuitry 180 included in the source device 110a discussed above. In further examples, at least some of the functionality associated with any one or more of the input/output (I/O) subsystem 140, the user interface and navigation subsystem 150, the satellite navigation subsystem 160, or the circuitry 180 may be implemented in software code executed by the processor 502.

The memory 504 can be implemented using any suitable type of digital storage including, for example, flash memory and/or random access memory (RAM). In some embodiments, the memory 504 may include various layers of memory hierarchy and/or memory caches. The memory 504 may be implemented as a volatile memory device such as, but not limited to, a RAM, dynamic RAM (DRAM), or static RAM (SRAM) device. The storage system 516 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. The storage device 516 and/or the memory 504 can be configured to store the configuration data discussed above.

The processor 502 may be configured to execute an Operating System (OS) 522 which may comprise any suitable operating system, such as Google Android (Google Inc., Mountain View, CA), Microsoft Windows (Microsoft Corp., Redmond, WA), Apple OS X (Apple Inc., Cupertino, CA), Linux or Linux variants, or a real-time operating system (RTOS). As will be appreciated in light of this disclosure, the techniques provided herein can be implemented without regard to the particular operating system provided in conjunction with the computing platform 500, and therefore may also be implemented using any suitable existing or subsequently-developed platform.

The network interface 508 can be any appropriate network chip or chipset which allows for wired and/or wireless connection between other components of platform 500 and/or network 520, thereby enabling the computing platform 500 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks. In some examples, the network interface may include, or may be coupled to, the one or more RF antennas 130 and/or the GNSS antenna 165 discussed above.

The I/O system 510 may be configured to interface between various I/O devices and other components of the computing platform 500. I/O devices may include, but may not be limited to, the user interface 512 and display element 514. The user interface 512 may include devices (not shown) such as a touchpad, keyboard, and mouse, etc., for example, to allow the user to control the system. In some examples, the user interface 512 may include a graphical user interface. The display element 514 may be configured to display information to a user. The I/O system 510 may include a graphics subsystem configured to perform processing of images for rendering on the display element 514. The graphics subsystem may be a graphics processing unit or a visual processing unit (VPU), for example. An analog or digital interface may be used to communicatively couple the graphics subsystem and the display element 514. For example, the interface may be any of a high definition multimedia interface (HDMI), DisplayPort, wireless HDMI, and/or any other suitable interface using wireless high definition compliant techniques. In some embodiments, the graphics subsystem could be integrated into the processor 502 or any chipset of the computing platform 500. The I/O system 510, the user interface 512, and the display element 514 can be configured to implement various functionality associated with the I/O subsystem 140 and/or the user interface and navigation subsystem 150 discussed above. In some instances, some or all of the functionality associated with the I/O subsystem 140 may be implemented using combinations of the network interface 508 (e.g., for providing a wireless interface), the I/O system 510, and/or the processor 502.

The GNSS engine 506 may be configured to receive and process GNSS signals received from one or more satellites as well as the GNSS receiver configuration data, as discussed above. Accordingly, the GNSS engine 506 may implement some or all of the functionality of the satellite navigation subsystem 160 discussed above. In addition, the GNSS engine 506 may implement at least some of the functionality of the GNSS system 400 discussed above. The GNSS engine 506 can be implemented or otherwise used in conjunction with a variety of suitable software and/or hardware that is coupled to or that otherwise forms a part of the computing platform 500. At least some of the functionality of the GNSS engine 506 may be implemented in software code executed by the processor 502.

It will be appreciated that in some embodiments, the various components of the computing platform 500 may be combined or integrated in a system-on-a-chip (SoC) architecture. In some embodiments, the components may be hardware components, firmware components, software components or any suitable combination of hardware, firmware or software.

In various embodiments, the computing platform 500 may be implemented as a wireless system, a wired system, or a combination of both. When implemented as a wireless system, the computing platform 500 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth.

Various embodiments may be implemented using hardware elements, software elements, or any combination thereof. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth.

Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In certain embodiments, the system may leverage processing resources provided by a remote computer system accessible via the network 520. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments, the computing platform 500 may comprise additional, fewer, or alternative subcomponents as compared to those included in the example embodiment of FIG. 5.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable medium for storing digital information, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

In alternative embodiments, the components and/or modules disclosed herein can be implemented with hardware, including gate-level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

### FURTHER EXAMPLE EMBODIMENTS

The following examples pertain to further embodiments, from which numerous permutations and configurations will be apparent.

Example 1 provides a system for wireless initialization of GNSS receivers, the system comprising at least one receiver node configured to track one or more GNSS satellites and to provide a navigation output, the at least one receiver node including a first wireless interface configured for wireless communications according to a first wireless communications protocol, and a source node. The source node includes a second wireless interface configured for wireless communications according to the first wireless communications protocol, a data storage device configured to store GNSS configuration data, the GNSS configuration data including information to be used by the at least one receiver node to initialize the at least one receiver node for navigational operation, and at least one processor coupled to the first wireless interface and to the data storage device. The at least one processor is configured to execute instructions that control the source node to establish, via the second wireless interface, a first wireless link with the at least one receiver node using the first wireless communications protocol, and transfer the GNSS configuration data to the at least one receiver node over the secure wireless link.

Example 2 includes the system of Example 1, wherein the receiver node is a GNSS receiver and wherein the source node is another GNSS receiver.

Example 3 includes the system of Example 2, wherein the other GNSS receiver comprises a full duplex transceiver.

Example 4 includes the system of any one of Examples 1-3, wherein the at least one GNSS receiver includes a plurality of GNSS receivers, and wherein the source node is configured to establish the first wireless link with each GNSS receiver of the plurality of GNSS receivers and to transfer the GNSS configuration data to the plurality of GNSS receivers simultaneously.

Example 5 includes the system of any one of Examples 1-4, wherein the first wireless link is a secure wireless link and wherein the first wireless communications protocol is a secure wireless communications protocol.

Example 6 includes the system of Example 5, wherein the secure wireless communications protocol is an intra-soldier wireless (ISW) protocol.

Example 7 includes the system of one of Examples 5 and 6, wherein the secure wireless link is an ultra-wideband radio frequency link.

Example 8 includes the system of any one of Examples 1-7, wherein the first wireless link is a short-range communication link having a maximum communication range of 200 meters.

Example 9 includes the system of any one of Examples 1-8, wherein the first wireless link has a maximum communication range of 10 meters.

Example 10 includes the system of any one of Examples 1-9, wherein, to establish the first wireless link with the at least one GNSS receiver, the source node is configured to pair with the at least one GNSS receiver.

Example 11 includes the system of any one of Examples 1-10, wherein the GNSS configuration data includes satellite almanac data corresponding to a geographic location of the source node and the at least one GNSS receiver.

Example 12 includes the system of any one of Examples 1-11, wherein, for transfer over the first wireless link, the GNSS configuration data is encrypted using AES-256 bit encryption.

Example 13 provides a method of initializing a GNSS receiver after power up in an unknown location. The method comprises identifying a source node located within 200 meters of the GNSS receiver, establishing a secure wireless communications link with the source node using a secure wireless communications protocol, receiving, from the source node via the secure wireless communications link, GNSS configuration data that includes satellite almanac data and timing information corresponding to the unknown location, and processing the GNSS configuration data to initialize the GNSS receiver for navigational operation in which the GNSS receiver tracks at least one GNSS satellite.

Example 14 includes the method of Example 13, wherein identifying the source node includes identifying a source node within 10 meters of the GNSS receiver.

Example 15 includes the method of Example 14, wherein establishing the secure wireless communications link includes establishing the secure wireless communications link using an intra-soldier wireless (ISW) protocol.

Example 16 includes the method of any one of Examples 13-15, wherein establishing the secure wireless communications link includes establishing the secure wireless communications link using an ultra-wideband radio link.

Example 17 includes the method of any one of Examples 13-16, wherein identifying the source node includes receiving a pairing request from the source node, and authorizing pairing with the source node.

Example 18 provides an apparatus for wireless initialization of GNSS receivers, the apparatus comprising a wireless interface configured for wireless communications according to a first wireless communications protocol having a maximum range of 200 meters, a data storage device configured to store GNSS configuration data, the GNSS configuration data including information to be used by at least one GNSS receiver to initialize the at least one GNSS receiver for navigational operation, and at least one processor coupled to the wireless interface and to the data storage device. The at least one processor is configured to execute instructions to establish, via the wireless interface, a first wireless link with the at least one GNSS receiver using the first wireless communications protocol, and transfer the GNSS configuration data to the at least one GNSS receiver over the first wireless link.

Example 19 includes the apparatus of Example 18, wherein the first wireless communications protocol is a secure wireless communications protocol and wherein the first wireless link is a secure wireless link.

Example 20 includes the apparatus of Example 19, wherein the secure wireless communications protocol has a maximum range of 10 meters.

Example 21 includes the apparatus of Example 20, wherein the secure wireless communications protocol is an intra-soldier wireless (ISM) protocol.

Example 22 includes the apparatus of any one of Examples 19-21, wherein the at least one GNSS receiver includes a plurality of GNSS receivers, and wherein at least one processor is further configured to execute instructions to establish, via the wireless interface, secure wireless links with each of the plurality of GNSS receivers using the secure wireless communications protocol, and transfer the GNSS configuration data to the plurality of GNSS receivers simultaneously over the secure wireless links.

Example 23 includes the apparatus of any one of Examples 18-22, wherein the apparatus is another GNSS receiver comprising a full duplex transceiver.

Example 24 includes the apparatus of any one of Examples 18-23, wherein the GNSS configuration data includes satellite almanac data and timing information corresponding to a geographic location of the at least one GNSS receiver.

Example 25 includes the apparatus of any one of Examples 18-24, wherein, for transfer over the first wireless link, the GNSS configuration data is encrypted using AES-256 bit encryption.

Example 26 provides a GNSS receiver comprising a wireless communications interface configured for wireless communications according to an intra-soldier wireless (ISW) communications protocol, a user interface configured to display navigational output, at least one processor coupled to the wireless communications interface and to the user interface, and a data storage device storing instructions that when executed by the at least one processor configure the GNSS receiver to identify a source device within wireless communications range of the GNSS receiver, establish, via the wireless communications interface, a secure wireless communications link with the source device, the secure wireless communications link being configured according to the ISW communications protocol, receive, from the source device via the secure wireless communications link, GNSS configuration data, based on the GNSS configuration data, acquire a fix on at least one GNSS satellite, and based on signals received from the at least one GNSS satellite, produce the navigational output.

Example 27 includes the GNSS receiver of Example 26, wherein to identify the source device, the at least one processor is configured to execute instructions that configure the GNSS receiver to identify a source device within 10 meters of the GNSS receiver.

Example 28 includes the GNSS receiver of one of Examples 26 and 27, wherein the GNSS configuration data includes satellite almanac data and timing information corresponding to a geographic location of the GNSS receiver.

Example 29 includes the GNSS receiver of Example 28, wherein the timing information includes at least one of Y-code data, M-code data, or C/A-code data.

Example 30 includes the GNSS receiver of any one of Examples 26-29, wherein the user interface includes a graphical user interface.

Example 31 provides a method of initializing a GNSS receiver after power up in an unknown location. The method comprises establishing, via a source node located within 200 meters of the GNSS receiver, a secure wireless communications link with the GNSS receiver using a secure wireless communications protocol, transmitting, to the GNSS receiver via the secure wireless communications link, GNSS configuration data that includes satellite almanac data and timing information corresponding to the unknown location, and processing the GNSS configuration data to initialize the GNSS receiver for navigational operation in which the GNSS receiver tracks at least one GNSS satellite.

Example 32 includes the method of Example 31, wherein establishing the secure wireless communications link includes establishing the secure wireless link via a source node located within 10 meters of the GNSS receiver.

Example 33 includes the method of Example 32, wherein establishing the secure wireless communications link includes establishing the secure wireless communications link using an intra-soldier wireless (ISW) protocol.

Example 34 includes the method of any one of Examples 31-33, wherein establishing the secure wireless communications link includes establishing the secure wireless communications link using an ultra-wideband radio link.

Example 35 includes the method of any one of Examples 31-34, wherein the timing information includes at least one of Y-code data, M-code data, or C/A-code data.

Example 36 provides a GNSS receiver comprising a GNSS engine coupled to an antenna and configured to process GNSS satellite data to provide at least one of position and navigation information, a wireless communications interface configured for wireless communications according to an intra-soldier wireless (ISW) communications protocol, a user interface configured to display navigational output, at least one processor coupled to the wireless communications interface and to the user interface, and a data storage device storing instructions that when executed by the at least one processor configure the GNSS receiver to identify a source device within wireless communications range of the GNSS receiver, establish, via the wireless communications interface, a secure wireless communications link with the source device, receive, from the source device via the secure wireless communications link, GNSS configuration data, based on the GNSS configuration data, acquire a fix on at least one GNSS satellite, and based on signals received from the at least one GNSS satellite, produce the at least one of position and navigational information.

Example 37 includes the GNSS receiver of Example 36, wherein to identify the source device, the at least one processor is configured to execute instructions that configure the GNSS receiver to identify a source device within 10 meters of the GNSS receiver.

Example 38 includes the GNSS receiver of one of Examples 36 and 37, wherein the GNSS configuration data includes satellite almanac data and timing information corresponding to a geographic location of the GNSS receiver.

Example 39 includes the GNSS receiver of Example 38, wherein the timing information includes at least one of Y-code data, M-code data, or C/A-code data.

Example 40 includes the GNSS receiver of any one of Examples 36-39, wherein the antenna is a GNSS antenna and further comprising a separate antenna for the wireless communications, wherein the separate antenna is coupled to the wireless communications interface.

What is claimed is:

1. A system for wireless initialization of GNSS receivers, the system comprising:
at least one receiver node configured to track one or more GNSS satellites and to provide a navigation output, the at least one receiver node including a first wireless interface configured for wireless communications according to a first wireless communications protocol; and
a source node including
a second wireless interface configured for wireless communications according to the first wireless communications protocol,
a data storage device configured to store GNSS configuration data, the GNSS configuration data including information to be used by the at least one receiver node to initialize the at least one receiver node for navigational operation, and
at least one processor coupled to the first wireless interface and to the data storage device, the at least one processor being configured to execute instructions that control the source node to
establish, via the second wireless interface, a first wireless link with the at least one receiver node using the first wireless communications protocol, and
transfer the GNSS configuration data to the at least one receiver node over the first wireless link.

2. The system of claim 1, wherein the source node is a GNSS receiver comprising a full duplex transceiver.

3. The system of claim 1, wherein the at least one receiver node includes a plurality of GNSS receivers, and wherein the source node is configured to establish the first wireless link with each of the plurality of GNSS receivers and to transfer the GNSS configuration data to the plurality of GNSS receivers substantially simultaneously.

4. The system of claim 1, wherein the first wireless communications protocol is a secure protocol.

5. The system of claim 1, wherein the first wireless link is one of an ultra-wideband radio frequency link or a wireless link configured according to an intra-soldier wireless (ISW) protocol.

6. The system of claim 1, wherein the first wireless link is a short-range communication link having a maximum communication range of about 200 meters.

7. The system of claim 1, wherein, to establish the first wireless link with the at least one receiver node, the source node is configured to pair with the at least one receiver node.

8. The system of claim 1, wherein the GNSS configuration data includes satellite almanac data corresponding to a geographic location of the source node and the at least one receiver node.

9. The system of claim 1, wherein, for transfer over the first wireless link, the GNSS configuration data is encrypted using AES-256 bit encryption.

10. An apparatus for wireless initialization of at least one GNSS receiver, the apparatus comprising:
a wireless interface configured for wireless communications according to a secure wireless communications protocol having a maximum range of about 200 meters;
a data storage device configured to store GNSS configuration data, the GNSS configuration data including information to be used by at least one GNSS receiver to initialize the at least one GNSS receiver for navigational operation; and
at least one processor coupled to the wireless interface and to the data storage device, the at least one processor being configured to execute instructions to
establish, via the wireless interface, a secure wireless link with the at least one GNSS receiver using the secure wireless communications protocol, and
transfer the GNSS configuration data to the at least one GNSS receiver over the secure wireless link.

11. The apparatus of claim 10, wherein the secure wireless communications protocol has a maximum range of about 10 meters.

12. The apparatus of claim 11, wherein the secure wireless communications protocol is an intra-soldier wireless (ISW) protocol.

13. The apparatus of claim 10, wherein the apparatus is a GNSS receiver comprising a full duplex transceiver.

14. The apparatus of claim 10, wherein the GNSS configuration data includes satellite almanac data and timing information corresponding to a geographic location of the at least one GNSS receiver.

15. The apparatus of claim 10, wherein, for transfer over the secure wireless link, the GNSS configuration data is encrypted using AES-256 bit encryption.

16. A GNSS receiver comprising:
a GNSS engine coupled to an antenna and configured to process GNSS satellite data to provide at least one of position and navigation information;
a wireless communications interface configured for wireless communications according to an intra-soldier wireless (ISW) communications protocol;
a user interface configured to display navigational output;
at least one processor coupled to the wireless communications interface and to the user interface; and
a data storage device storing instructions that when executed by the at least one processor configure the GNSS receiver to
identify a source device within wireless communications range of the GNSS receiver,
establish, via the wireless communications interface, a secure wireless communications link with the source device,
receive, from the source device via the secure wireless communications link, GNSS configuration data,
based on the GNSS configuration data, acquire a fix on at least one GNSS satellite, and
based on signals received from the at least one GNSS satellite, produce the at least one of position and navigational information.

17. The GNSS receiver of claim 16, wherein to identify the source device, the at least one processor is configured to execute instructions that configure the GNSS receiver to identify a source device within 10 meters of the GNSS receiver.

18. The GNSS receiver of claim 16, wherein the GNSS configuration data includes satellite almanac data and timing information corresponding to a geographic location of the GNSS receiver.

19. The GNSS receiver of claim 18, wherein the timing information includes at least one of Y-code data, M-code data, or C/A-code data.

20. The GNSS receiver of claim 16, wherein the antenna is a GNSS antenna and further comprising a separate antenna for the wireless communications, wherein the separate antenna is coupled to the wireless communications interface.
